(19) United States
(12) Patent Application Publication
(10) Pub. No.: US 2016/0148501 A1
(43) Pub. Date: May 26, 2016

(54) Multi-Layer Wireless Communication

(71) Applicant: MivaLife Mobile Technology, Inc., George Town, KY (US)

(72) Inventors: Duxing Mou, Dublin, CA (US); Kuochun Lee, Fremont, CA (US); Qiang Xie, Wuhan City (CN)

(73) Assignee: MivaLife Mobile Technology, Inc., George Town, KY (US)

(21) Appl. No.: 14/549,921

(22) Filed: Nov. 21, 2014

(51) Int. Cl. G08C 17/02

(52) U.S. Cl. CPC G08C 17/02

(57) ABSTRACT

Methods, systems, and apparatus for wireless communications. One device includes one or more sensing components; a microcontroller unit; and a wireless module, the wireless module configured to selectively operate in an active mode and a low power sleep mode, wherein the microcontroller unit is configured to analyze signals from the one or more sensing components and to selectively place the wireless modules in the active or sleep mode depending on the analysis.

### BACKGROUND

This specification relates to wireless communications.

Usually, a complex system design faces different constraints that include security, energy consumption, range, sensitivity, and density. Some nodes of a system are often partially alive or working with different sensitivity. Some nodes are also typically linked using different physical connections. The system design also typically needs to consider the redundancy and durability when it is under attack or experiencing failure.

Conventional home security systems operate using an external electrical source, e.g., a connection to an electrical outlet of a home electrical system. Some home security devices include a battery backup that allows the respective devices to maintain function when the external power is lost. However, a device operating on battery typically operates at full functionality and has a limited lifespan based on battery capacity.

### SUMMARY

In general, one innovative aspect of the subject matter described in this specification can be embodied in sensor devices that include one or more sensing components; a microcontroller unit; and a wireless module, the wireless module configured to selectively operate in an active mode and a low power sleep mode, wherein the microcontroller unit is configured to analyze signals from the one or more sensing components and to selectively place the wireless modules in the active or sleep mode depending on the analysis.

The foregoing and other embodiments can each optionally include one or more of the following features, alone or in combination. In particular, one embodiment includes all the following features in combination. One of the sensing components can be a door sensor, a window sensor, a motion sensor, or a temperature sensor. One of the sensing components can be a camera device or an actuator device. In response to a determination by the microcontroller unit that an alert has occurred, the microcontroller unit signals the wireless module to operate in the active mode. The microcontroller unit transmits an alert to a management device. The sensor device further includes a battery that provides backup power when an external power source becomes unavailable.

In general, one innovative aspect of the subject matter described in this specification can be embodied in sensor devices that include a sensor coupled to an analog circuit; a wireless module the wireless module configured to selectively operate in an active mode and a low power sleep mode; and a microcontroller unit coupled to the analog circuit and to the wireless module, wherein the analog circuit selectively activates the microcontroller unit in response to analysis of data from the sensor according to a first criterion.

The foregoing and other embodiments can each optionally include one or more of the following features, alone or in combination. In particular, one embodiment includes all the following features in combination. The microcontroller unit selectively activates the wireless module in response to analysis of data from the sensor according to a second criterion. In response to a determination by the microcontroller unit that an alert has occurred according to the second criterion, the microcontroller unit signals the wireless module to operate in the active mode. In a first state the sensor and the analog circuit are in an active mode while the microcontroller unit and the wireless module are in a sleep mode.

In general, one innovative aspect of the subject matter described in this specification can be embodied in sensor devices that include one or more sensing components; a microcontroller unit; a wireless module, the wireless module configured as a primary communication mode; and a secondary receiver/transmitter module.

The foregoing and other embodiments can each optionally include one or more of the following features, alone or in combination. The microcontroller unit is configured to analyze signals from the one or more sensing components and to send a signal to another device using the secondary receiver/transmitter module in response to the analysis.

In general, one innovative aspect of the subject matter described in this specification can be embodied in systems that include a plurality of wireless devices, each wireless device including a primary Wi-Fi communication module and a secondary receiver/transmitter module, wherein each wireless device is configured to communicate with at least one other wireless device of the plurality of wireless devices according to a Wi-Fi network using the primary Wi-Fi communication module and a secondary network using the secondary receiver/transmitter module.

The foregoing and other embodiments can each optionally include one or more of the following features, alone or in combination. The primary Wi-Fi network is used for communications between wireless devices in a primary mode of operation and wherein the secondary network is used for communications between wireless devices for one or more power saving tasks.

In general, one innovative aspect of the subject matter described in this specification can be embodied in methods that include the actions of receiving an indication at a wireless device of a failure of an external power supply; maintaining operation of the wireless device using a backup battery including placing the wireless device in a low power mode including placing a Wi-Fi module into a sleep mode; analyzing sensor data to determine that a triggering event has occurred; returning the Wi-Fi module to an active mode and using the Wi-Fi module to transmit an alert; and returning the Wi-Fi module to the sleep mode.

The foregoing and other embodiments can each optionally include one or more of the following features, alone or in combination. Analyzing sensor data to determine that the triggering event has occurred includes: using a first low power circuit to analyze the sensor data according to a first criterion; in response to determining that the first criterion is satisfied, activating a microcontroller unit; using the microcontroller unit to analyze the sensor data according to a second criterion; and in response to determining that the second criterion is satisfied, determining that the triggering event has occurred.

In general, one innovative aspect of the subject matter described in this specification can be embodied in methods that include the actions of receiving an indication at a wireless device of a failure of an external power supply; maintaining operation of the wireless device using a backup battery including placing the wireless device in a low power mode including placing a Wi-Fi module into a sleep mode; analyzing sensor data to determine that a triggering event has occurred; and activating a low power secondary communication mode distinct from the Wi-Fi module, the secondary communication mode configured to transmit an alert to at least one other device in response to the triggering event.

The subject matter described in this specification can be implemented in particular embodiments so as to realize one or more of the following advantages. Activation of a Wi-Fi module in a wireless device can be limited to situations in which an associated sensor triggers an event. This reduces battery drain in the wireless device by limiting active time of the Wi-Fi module. A secondary data receiving/transmitter (R/T) module can be used to wake up the Wi-Fi module in response to incoming requests, e.g., from a user of the system, thus enabling two way communications while conserving power usage. A secondary network established using the secondary R/T modules can be used with an established Wi-Fi network to diagnose network problems including Wi-Fi network failure under power outage, battery shortage, or internet interruption. The secondary network can also be used to send/receive frequently transmitted data without using the Wi-Fi modules, which reduces power consumption by the wireless device. For example, low sensitivity data such as temperature or humidity sensor measurements can be frequently sent between devices using the secondary network. The system can be automatically self-calibrated using the Wi-Fi network and the secondary network data.

The details of one or more embodiments of the subject matter of this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example wireless sensor device.

FIG. 2 is a block diagram of an example wireless sensor device with two stage analysis.

FIG. 3 is a block diagram of an example wireless sensor device with a secondary receiver/transmitter module.

FIG. 4 is a block diagram illustrating secondary communication between two wireless devices.

FIG. 5 is a block diagram of an example system using Wi-Fi and secondary receiver/transmitters.

Like reference numbers and designations in the various drawings indicate like elements.

### DETAILED DESCRIPTION

Wireless (for instance, Wi-Fi-based) sensors are often used in a network, for example, as part of a security or monitoring system. Wireless communications for the sensors include not only Wi-Fi, but also other wireless protocols including RF433 MHz protocol, Z-wave, etc. For convenience this specification will often refer to Wi-Fi and Wi-Fi modules, but any suitable wireless protocol can be used to achieve the same features. These sensors are also often battery powered. However, this can lead to large battery draining issues. To reduce battery draining, one conventional approach is to reduce the occurrence of data reception and transmission from a Wi-Fi access point. For example, the wireless device can be configured to periodically wake up a Wi-Fi module to connect to the access point or other management device while otherwise being in a sleep or low power mode. The frequency and duration of the active wake-up mode for the Wi-Fi module of the wireless device will influence the battery power consumption. For example, if the Wi-Fi module is woken up frequently to send data, the power drain on the battery will be greater. Additionally, the communication is driven by the individual wireless devices since the access point cannot wake up the Wi-Fi module of the wireless device until a handshake is initiated by the Wi-Fi module.

Some other wireless devices use an in-chip ARM processor for sensor data processing. However, this design is can be complex and suffer from inefficiencies from a power management standpoint. When the ARM wireless device is awake, it consumes more power than a more primitive microcontroller unit (“MCU”). The ARM processor also controls the Wi-Fi module on the same chip, if the ARM processor running the Wi-Fi module cannot be fully disabled. Consequently, the power consumption will generally be higher by using an in-chip ARM processor as the main processor rather than using an external MCU.

This specification describes a cross-connected mesh network with multi-tier collaboration management to achieve the balance between power and durability. The network consists of multi-tier data reception and transmission modules using different channels of communication.

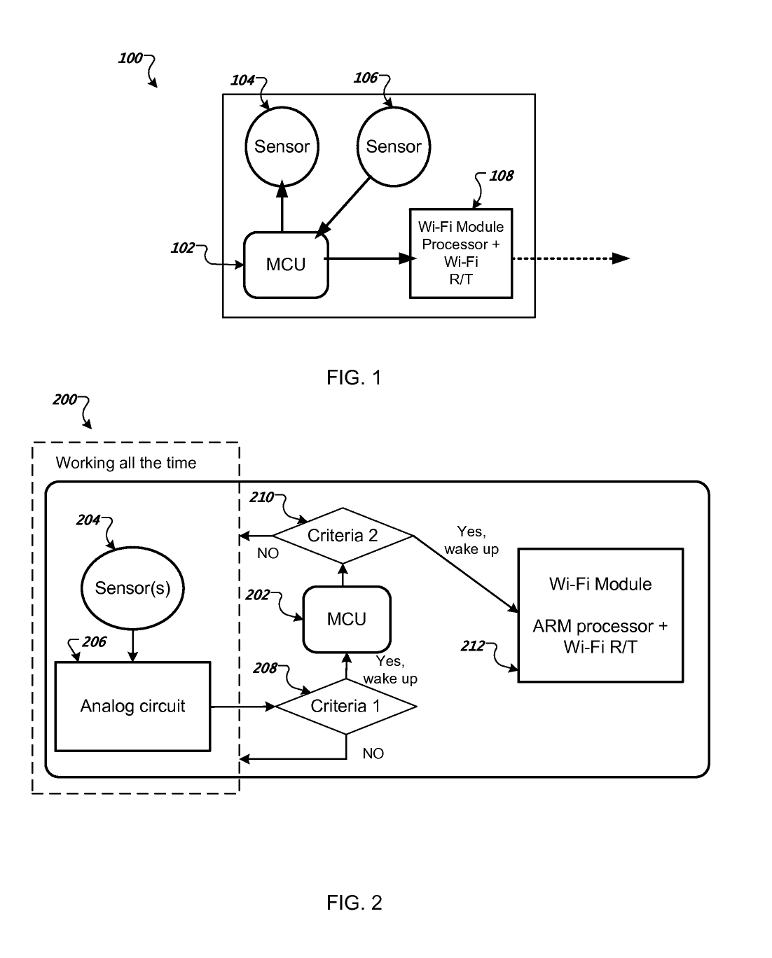

FIG. 1 is a block diagram of an example sensor device 100. The sensor device 100 includes a central controller as an MCU 102, a first sensing component 104, a second sensing component 106, and a Wi-Fi module 108.

The first sensing component 104 and the second sensing component 106 can each be a particular type of sensor including a motion sensor, a vibration sensor, a light sensor, temperature sensor, water sensor, etc. The sensor can also be a camera or other monitoring sensor. The MCU 102 can be a specialized very low power device. The MCU 102 typically performs simple logic, for example, threshold filtering and analog to digital conversion. The MCU 102 receives data from each of the first sensing component 104 and the second sensing component 106. The MCU 102 processes the received data to generate a computed output. In particular, the MCU 102 is configured to take full responsibility for determining whether an event is triggered based on sensor related data processing for data received from the sensing components 104 and 106.

If the computed output indicates that a valid event has been triggered, the MCU 102 wakes up the Wi-Fi module 108. Once in active mode, the Wi-Fi module 108 sends the triggered alert to a management device (not shown) using the transmitter of the Wi-Fi module 108.

For example, the sensor device 100 can be part of a local security system that includes a management device and one or more other wireless enabled devices such as additional sensors, cameras, door/window actuators, etc. The Wi-Fi module 108 can communicate with the management device, for example, after using an authentication handshake to reestablish communication. The management device can be, or be coupled to, and access point device configured to provide external communications e.g., through internet access, for example using an Ethernet or other broadband connection. The management device can establish a secure wireless network among various devices in a system including the sensor device 100 as well as perform configuration and management functions for the system including the sensor device 100.

The management device receives the alert from the sensor device 100 and may perform more processing before determining a next action, e.g., notifying a server or cloud based management system to take further action, activating an alarm, triggering a local alarm based on programmed local logic if an external service provider system e.g., a server or cloud based system, is not available, etc. The processing can include determining a state of the system, e.g., armed or disarmed as well as applying one or more security rules to the received alert to determine whether or not an event has been triggered.

In some implementations, the MCU 102 places the Wi-Fi module 108 back into sleep mode following transmission of the alert to the management device. Alternatively, in some other implementations, the MCU 102 may wait a specified period of time for incoming commands from the management device before placing the Wi-Fi module 108 back to sleep.

In the sensor device 100, the Wi-Fi module 108 is only activated when a valid event is determined to minimize power consumption. For example, particular MCUs require a much lower level of power input than a typical Wi-Fi module to operate. The MCU 102 takes full responsibility for processing the sensor data. However, since the MCU 102 consumes significantly less electricity than the Wi-Fi module 108, the Wi-Fi module 108 is limited to operating in active mode only when the event triggering criteria has been satisfied.

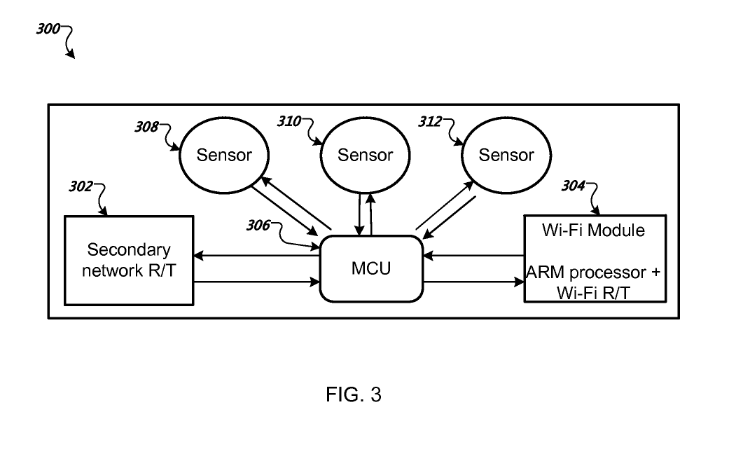

In the sensor device 100, the sensor device 100 cannot receive communications when the Wi-Fi module 108 is in sleep mode. Thus, the management device cannot generally initiate communication with the sensor device 100. As a result, when the system is disarmed, the MCU 102 is not notified and may continue to respond to the management device with sensor detected events that are not overall triggering given that the system is in a disarmed state. As described below with respect to FIG. 3, a secondary receiver/transmitter module can be added that adopts two-way communication between devices while consuming less power than simply running the Wi-Fi module.

FIG. 2 is a block diagram of an example wireless sensor device 200 with two-stage analysis of sensor data. Some types of sensor devices may benefit from one or more criteria to determine the valid status of a sensor event. For example, two stage criteria can be used to determine whether a current level of water, sound, temperature, humidity, brightness, or chemical matters exceeds a certain threshold or meets the existence of a certain pattern. For example, a sensor device providing entrance detection can have a first stage directed to determine whether a door is opened and a second stage directed to using motion detection to determine whether someone is entering or leaving the room/building.

The sensor device 200 includes an MCU 202, sensor(s) 204, an analog circuit 206, and a Wi-Fi module 212. In particular, in the sensor device 200, only the sensor 204 and the analog circuit 206 are always on and responsive to the current environment, e.g., sensor measurements. Thus, initially the sensor 204 and analog circuit 206 form a low power sensing mode, which determines a next level of activity based on analysis of sensor data.

The sensor 204 can be similar to the sensing components 104/106 described above with respect to FIG. 1. The analog circuit 206 is an ultra-low power circuit that is configured to detect sensor values that are larger or smaller than a specified threshold value, indicated by first criterion decision block 208. If the threshold is satisfied, the analog circuit 206 activates the MCU 202. The MCU 202 then is active to process the sensor data further to determine whether or not an event is triggered, indicated by second criteria decision block 210. If the second criterion is satisfied, an event is determined to have been triggered and the MCU 202 activates the Wi-Fi module 212. The Wi-Fi module 212 can then perform functions as described above with respect to FIG. 1 including transmitting the event to a management device for further processing.

The cascading design of the sensor device 200 having a power saving operation at each stage to determine a next level of activity can provide further power savings compared to other wireless sensors including the wireless sensor 100 of FIG. 1. In some alternative implementations, a parallel logic can be used to check two or more criterion prior to activating one or more stages, e.g., two parallel checks of threshold values for respective criterions before activating Wi-Fi module.

FIG. 3 is a block diagram of an example wireless sensor device 300 with a secondary receiver/transmitter module. The sensor device 300 includes a secondary network receiver/transmitter (“R/T”) module 302, which can be used to provide low power two-way communication between two or more devices when a higher power Wi-Fi module 304 is in low power or sleep mode.

In particular, the wireless sensor device 300 includes an MCU 306. The MCU 306 is similar to the MCUs described above. In particular, the MCU 306 receives data from, and can transmit data to, one or more sensors in the sensor device 300. The MCU 306 is communicatively coupled to the secondary network R/T module 302 and the Wi-Fi module 304.

In the specific example shown in sensor device 300, three sensors, sensor 308, 310, and 312, are in communication with the MCU 306. However, any suitable number of sensors can be included. Additionally, in some implementations, a device may not have any sensors. For example, the device can operate as a repeater for one or more communication modes Wi-Fi and one or more secondary modes.

In the sensor device 300, the Wi-Fi module 304 is the primary mode of transmission/reception of data. The secondary network R/T module 302 provides a built-in secondary data reception/transmission mode for performing two way communications with less power consumption than the Wi-Fi module 304. The secondary network R/T module 302 can operate using one or more optical forms of communication including, e.g., infrared, laser, LED optical, or other optical signals; or one or more radio frequency forms of communication including RF, BLUETOOTH, low energy BLUETOOTH, Zigbee, or Z-wave. In some implementations, a device can selectively operate in one of multiple secondary modes.

In the event of failure in the primary Wi-Fi mode, the secondary mode will take over communications for the sensor device 300. Failure of the primary mode can include placing the sensor device 300 into a power saving mode in response to a loss of a direct power source, e.g., wired power adapter to a building power source. The secondary network R/T module 302 consumes less power, particularly when the sensor device 300 is in low power mode. However, the secondary network R/T 302 typically has a smaller communication range relative to the Wi-Fi module 304. For example, physical walls or other objects in a building can limit the communication range of the secondary network R/T module 302. To extend the range of the secondary network R/T modules, the device can communicate with one or more other devices of a system as described in greater detail below.

In some implementations, the sensor device 300 is one of several devices within a particular system, for example, a security or monitoring system. Active devices in the system can communicate with each other using the secondary network such that they can each act as repeaters to extend the range of sensor device communications when using the secondary network. For example, a system can include multiple wireless sensors each using a respective Wi-Fi module as the primary mode of communication with a system management device. Additionally, the wireless devices can incorporate respective secondary network R/T modules to provide secondary communication, for example, when wireless devices are placed in a low power mode using battery backup power. Each wireless device can act as a repeater for transmitting or receiving data directed to one or more wireless devices in the system. In some implementations, any suitable device with a Wi-Fi module is capable of being operated in a repeater mode.

Once the system including multiple wireless devices is established, a cross-connected mesh network is established between all of the wireless devices. A measure of signal strength can be used to calibrate connectivity between wireless devices in the system. This calibration can be used to help improve the connectivity or signal integrity of the system. For example, when the signal integrity is poor or does not exist, the user can be notified, for example, by a management device in the system or by a remote based server provider system, to add an additional device with repeater capabilities into the network at a location that improvise signal integrity. The calibration can be performed as part of a heart-beat process monitoring interconnectivity between the secondary R/T modules of the system.

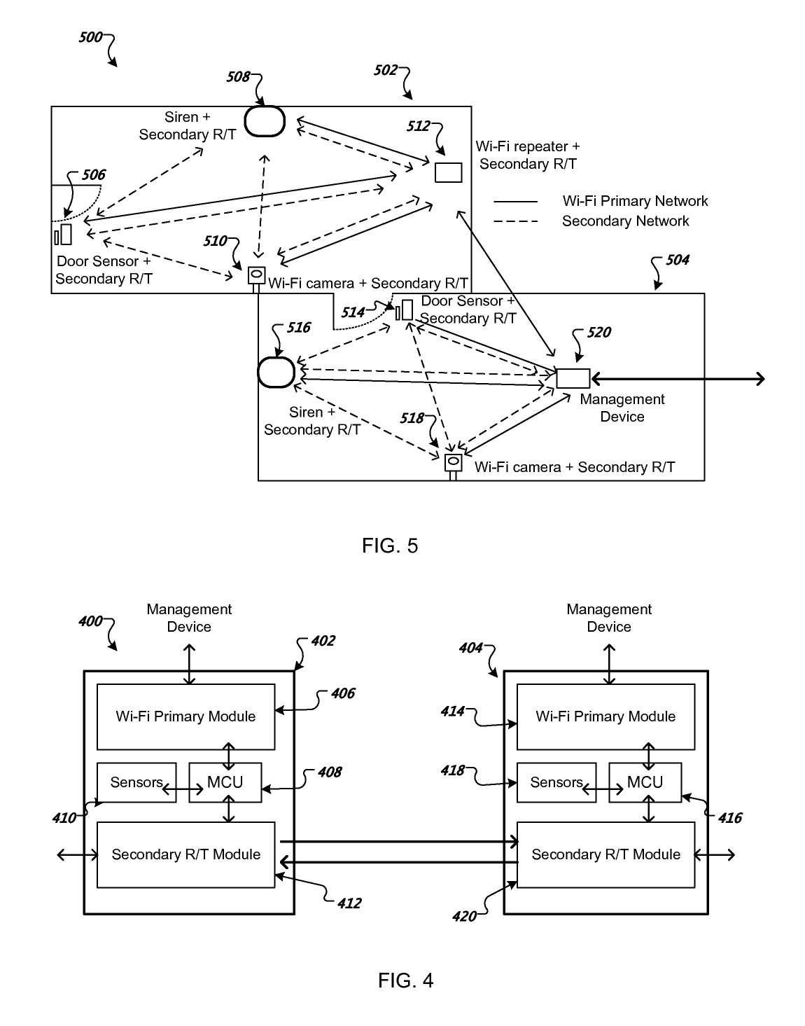

FIG. 4 is a block diagram illustrating secondary communication between two wireless devices. In particular, FIG. 4 shows a first wireless device 402 and a second wireless device 404. The first wireless device 402 includes a first Wi-Fi module 406, a first MCU 408, one or more first sensors 410, and a first secondary R/T module 412. Similarly, the second wireless device 404 includes a second Wi-Fi module 414, a second MCU 416, one or more second sensors 418, and a second secondary R/T module 420.

The Wi-Fi modules, MCUs, sensors, and secondary R/T modules can be similar to those described above with respect to FIGS. 1-3. In some alternative implementations, one of the first and second wireless devices 402/404 does not include any sensors, but instead acts as a repeater for communications using the secondary R/T module.

As shown in FIG. 4, each of the first Wi-Fi module 406 and the second Wi-Fi module 414 act as a primary communication mode for the respective wireless devices. Each Wi-Fi module is respectively configured to communicate with one or more other devices, in particular, a management device for the system either locally or a remote service provider that provides management and support for multiple distinct local systems.

The first and second secondary R/T modules 412/420 can be activated in a low power mode of the first wireless device 402 or the second wireless device 404, respectively. In low power mode, the first and second secondary R/T modules 412/420 can communicate with each other as shown in FIG. 4. Thus, the wireless devices of the system can communicate with each other, for example, to relay messages generated or received by one of the wireless devices to another wireless device of the system. In some implementations, the Wi-Fi and secondary R/T can both be fully operational, and thus separate “active” and “low power” modes are not necessary. For example, the secondary tier network can be always on or sometimes on, depending on a particular configuration. The secondary network can reduce power consumption of the primary network by using lower power signals to perform particular tasks, for example, as part of the calibration, heartbeat, wake up processes as well as to transmit frequent data in certain circumstances without using higher power Wi-Fi communications.

In some implementations, the use of the secondary R/T module in a device such as shown in FIGS. 3 and 4 can be combined with the cascading criteria shown in FIG. 2 to provide additional power savings such that one or more criterion are tested prior to activating the secondary R/T module.

FIG. 5 is a block diagram of an example system 500 using Wi-Fi and secondary receiver/transmitters. In particular, the system 500 is represented by different types of wireless devices positioned relative to a first room 502 and a second room 504. For example, the wireless devices can be part of a home security system and the first room 502 and the second room 504 can represent two rooms in a home.

The first room 502 includes a first door sensor 506, a first siren 508, a first Wi-Fi camera 510, and a Wi-Fi repeater 512. The second room 504 includes a second door sensor 514, a second siren 516, a second Wi-Fi camera 518, and a security management device 520.

In the first room 502, the first door sensor 506 is a battery powered sensor and includes a secondary R/T module. The door sensor 506 can, for example, detect when a particular door is opened or closed. The first siren 508 is powered directly and includes a battery backup. The first siren 508 also includes a secondary R/T module. The first siren 508 can provide an audible alarm in response to a triggering event in the security system. The first Wi-Fi camera 510 is powered directly and includes a secondary R/T module. The first Wi-Fi camera 510 can capture continually when the system is armed or in response to a signal from another device. For example, the Wi-Fi camera 510 can be configured to activate in response to a signal from the first door sensor 506 indicating that the door has been opened while the system is armed.

The Wi-Fi repeater 512 is powered directly and includes a secondary R/T module. The Wi-Fi repeater 512 is used to transmit Wi-Fi signals from other devices to boost their range. For example, the Wi-Fi repeater 512 can relay Wi-Fi signals between the devices in the first room 502 and the security management device 520.

In the second room 504, the second door sensor 514 is a battery powered sensor and includes a secondary R/T module. The second siren 516 is powered directly and includes a battery backup and a secondary R/T module. The second siren 516 can provide an audible alarm in response to a triggering event in the security system. The second Wi-Fi camera 518 is powered directly and includes a secondary R/T module. The second Wi-Fi camera 518 can capture continually when the system is armed or in response to a signal from another device.

FIG. 5 further illustrates communication between devices using Wi-Fi as solid lines and using the secondary mode as dashed lines. In the primary Wi-Fi communications mode, the first door sensor 506, first siren 508, and first Wi-Fi camera 510 in the first room 502 send and receive Wi-Fi signals directly with the Wi-Fi repeater 512. The Wi-Fi repeater 512 then communicates using Wi-Fi to the security management device 520. For example, if the first door sensor 506 detects a door opening, it can send an alert signal to the Wi-Fi repeater 512, which then relays the alert to the security management device 520. The security management device 520 can analyze the alert and determine whether or not an event has been triggered. In response to the determination, the security management device 520 can send a signal to the first siren 508 by way of the Wi-Fi repeater 512. Additionally, the security management device 520 can notify a remote service provider system. The remote service provider system can, for example, notify one or more authorized users associated with the security system of the triggered alert, e.g., using mobile devices of the users.

If there is a power outage, the devices with battery backup continue to operate. However, they may power down their respective Wi-Fi modules in sleep mode to conserve power usage. In those instances, the devices with a secondary R/T module can use them to maintain communication with other battery powered or battery backup devices in the system 500. For example, as shown in the system 500, the first door sensor 506 can use the secondary R/T module to communicate with the first siren 508, the first Wi-Fi camera 510, and the Wi-Fi repeater 512. If the security system is armed when the power outage occurs, the system can still perform the sensing and alerting functions. In addition, since the secondary R/T modules provide two way communications between devices, commands can be received from the security management device or a remote user of the system.

The secondary R/T modules of each device communicate with each other to form a mesh crossed network. If an authorized user of the system sends a command to acquire current status information or data e.g., sensor status or camera video, the secondary data R/T modules will be able to wake up the respective primary Wi-Fi module of the device. When data transmission is completed, the wireless device can change the primary Wi-Fi module status into sleep mode.

The mesh network established by the secondary R/T modules can be used to communicate with other devices of the system to determine whether the primary Wi-Fi network failure was caused by a power outage, battery shortage, or internet interruption.

If all battery-powered sensor devices can successfully establish communication with each other device using the secondary R/T modules when the primary Wi-Fi mode fails, the devices may operate under a presumption that the a power outage has occurred. Under such circumstances the mesh network formed by the secondary R/T modules takes over to perform operations of the system. For example, if a system includes a sensor device, e.g., a motion senor, and a camera device, activation of the sensor device can cause the sensor device to use the secondary R/T module to notify the camera device to begin recording.

When the primary Wi-Fi network is active, but the connection between the system and a remote system cannot be established, the system may assume that there is an internet service outage. For example, the security management device may be unable to establish communication with a remote service provider system. The system will act locally to the extent possible. For example, if a sensor device detects a triggered event, the security management device can locally command a camera to begin recording in the vicinity of the sensor device as well as command a siren device to start an alarm.

In some implementations, particular types of data can be sent using the secondary R/T network instead of activating the Wi-Fi modules. For example, some low sensitivity data, such as real-time temperature, humidity, and/or brightness data from respective sensors, require frequent data transfers. Continually enabling primary Wi-Fi module of the sensor devices to send this data can result in a rapid power drain. Thus, the secondary R/T modules can take over responsibility for transmitting/receiving such non-sensitive data.

In some implementations, automatic self-calibration can be performed for both the Wi-Fi network and the secondary R/T network. Multi-tier collaboration system provides the ability to achieve automatic self-calibration for the system. In particular, the secondary tier mesh network provides a second network in operation in a same space and that allows for performance of various power saving tasks including network and device calibration, wake-up of low power devices, communications, and heartbeat functionalities. Once the system is set up, the sensor and device list of the primary Wi-Fi network will be established. In addition to the primary network, the sensor and device list related to the secondary tier network will also be established, e.g., within a particular room. Since the two tiers of sensors can provide attendance list and do a cross-examination, the self-calibration for both tiers can be achieved based on the cross-examination result, its logical relationship, and devices attendance list in both tiers.

If the connection of both primary and secondary link cannot be established for a sensor device, while others are working appropriately, the sensor device may have a battery, Internet or/and system hardware failures. The user can be alerted to check the sensor's battery and internet first using a system notification.

For one or more sensors/devices in an area, if the connection of primary network can be established, but not all sensors/devices in this area are connected, and the secondary network can be established, the area may need a Wi-Fi repeater and a secondary network R/T module repeater to increase the sensor range/Wi-Fi coverage. Similarly, for one or more sensors/devices in an area, if the connection of secondary network can be established, but not all sensors/devices in this area are connected, and the primary network can be established, the area may need a Wi-Fi repeater and a secondary network R/T module.

In some implementations, there are two or more tiers of R/T modules and signal modes available to the wireless devices, if one of R/T mode is not working correctly, or the system detect any event to indicate this R/T method is under attack or has been hacked, the primary Wi-Fi module will request the server to re-define R/T communication protocol and notify users. For example, if using infrared as the secondary R/T methods, the infrared has a relatively short range and only can be attacked in the same area like next to windows or glass, if an attacker tries to intercept and break the communication protocol, the system can update its protocol by Wi-Fi module or any module that is not under attack.

Embodiments of the subject matter and the functional operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible non-transitory storage medium for execution by, or to control the operation of, data processing apparatus. The computer storage medium can be a machine-readable storage device, a machine-readable storage substrate, a random or serial access memory device, or a combination of one or more of them. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus.

The term “data processing apparatus” refers to data processing hardware and encompasses all kinds of apparatus, devices, and machines for processing data, including by way of example a programmable processor, a computer, or multiple processors or computers. The apparatus can also be, or further include, special purpose logic circuitry, e.g., an FPGA (field programmable gate array) or an ASIC (application-specific integrated circuit). The apparatus can optionally include, in addition to hardware, code that creates an execution environment for computer programs, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages; and it can be deployed in any form, including as a stand-alone program or as a module, component, subroutine, or other unit suitable for use in a computing environment. A program may, but need not, correspond to a file in a file system. A program can be stored in a portion of a file that holds other programs or data, e.g., one or more scripts stored in a markup language document, in a single file dedicated to the program in question, or in multiple coordinated files, e.g., files that store one or more modules, sub-programs, or portions of code. A computer program can be deployed to be executed on one computer or on multiple computers that are located at one site or distributed across multiple sites and interconnected by a data communication network.

The processes and logic flows described in this specification can be performed by one or more programmable computers executing one or more computer programs to perform functions by operating on input data and generating output. The processes and logic flows can also be performed by special purpose logic circuitry, e.g., an FPGA or an ASIC, or by a combination of special purpose logic circuitry and one or more programmed computers.

Computers suitable for the execution of a computer program can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data. The central processing unit and the memory can be supplemented by, or incorporated in, special purpose logic circuitry. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks.

Control of the various systems described in this specification, or portions of them, can be implemented in a computer program product that includes instructions that are stored on one or more non-transitory machine-readable storage media, and that are executable on one or more processing devices. The systems described in this specification, or portions of them, can each be implemented as an apparatus, method, or electronic system that may include one or more processing devices and memory to store executable instructions to perform the operations described in this specification.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (LAN) and a wide area network (WAN), e.g., the Internet.

The computing system can include clients and servers. A client and server are generally remote from each other and typically interact through a communication network. The relationship of client and server arises by virtue of computer programs running on the respective computers and having a client-server relationship to each other. In some embodiments, a server transmits data, e.g., an HTML page, to a user device, e.g., for purposes of displaying data to and receiving user input from a user interacting with the user device, which acts as a client. Data generated at the user device, e.g., a result of the user interaction, can be received from the user device at the server.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A sensor device comprising:
one or more sensing components;
a microcontroller unit; and
a wireless module, the wireless module configured to selectively operate in an active mode and a low power sleep mode,
wherein the microcontroller unit is configured to analyze signals from the one or more sensing components and to selectively place the wireless modules in the active or sleep mode depending on the analysis.

2. The sensor device of claim 1, wherein one of the sensing components can be a door sensor, a window sensor, a motion sensor, or a temperature sensor.

3. The sensor device of claim 1, wherein one of the sensing components can be a camera device or an actuator device.

4. The sensor device of claim 1, wherein in response to a determination by the microcontroller unit that an alert has occurred, the microcontroller unit signals the wireless module to operate in the active mode.

5. The sensor device of claim 4, wherein the microcontroller unit transmits an alert to a management device.

6. The sensor device of claim 1, further comprising a battery that provides backup power when an external power source becomes unavailable.

7. A sensor device comprising:
a sensor coupled to an analog circuit;
a wireless module the wireless module configured to selectively operate in an active mode and a low power sleep mode; and
a microcontroller unit coupled to the analog circuit and to the wireless module,
wherein the analog circuit selectively activates the microcontroller unit in response to analysis of data from the sensor according to a first criterion.

8. The sensor device of claim 7, wherein the microcontroller unit selectively activates the wireless module in response to analysis of data from the sensor according to a second criterion.

9. The sensor device of claim 7, wherein in response to a determination by the microcontroller unit that an alert has occurred according to the second criterion, the microcontroller unit signals the wireless module to operate in the active mode.

10. The sensor device of claim 7, wherein in a first state the sensor and the analog circuit are in an active mode while the microcontroller unit and the wireless module are in a sleep mode.

11. A sensor device comprising:
one or more sensing components;
a microcontroller unit;
a wireless module, the wireless module configured as a primary communication mode; and
a secondary receiver/transmitter module.

12. The sensor device of claim 11, wherein the microcontroller unit is configured to analyze signals from the one or more sensing components and to send a signal to another device using the secondary receiver/transmitter module in response to the analysis.

13. A system comprising:
a plurality of wireless devices, each wireless device including a primary Wi-Fi communication module and a secondary receiver/transmitter module, wherein each wireless device is configured to communicate with at least one other wireless device of the plurality of wireless devices according to a Wi-Fi network using the primary Wi-Fi communication module and a secondary network using the secondary receiver/transmitter module.

14. The system of claim 13, wherein the primary Wi-Fi network is used for communications between wireless devices in a primary mode of operation and wherein the secondary network is used for communications between wireless devices for one or more power saving tasks.

15. A method comprising:
receiving an indication at a wireless device of a failure of an external power supply;
maintaining operation of the wireless device using a backup battery including placing the wireless device in a low power mode including placing a Wi-Fi module into a sleep mode;
analyzing sensor data to determine that a triggering event has occurred;
returning the Wi-Fi module to an active mode and using the Wi-Fi module to transmit an alert; and
returning the Wi-Fi module to the sleep mode.

16. The method of claim 15, wherein analyzing sensor data to determine that the triggering event has occurred comprises:
using a first low power circuit to analyze the sensor data according to a first criterion;
in response to determining that the first criterion is satisfied, activating a microcontroller unit;
using the microcontroller unit to analyze the sensor data according to a second criterion; and
in response to determining that the second criterion is satisfied, determining that the triggering event has occurred.

17. A method comprising:
receiving an indication at a wireless device of a failure of an external power supply;
maintaining operation of the wireless device using a backup battery including placing the wireless device in a low power mode including placing a Wi-Fi module into a sleep mode;
analyzing sensor data to determine that a triggering event has occurred; and
activating a low power secondary communication mode distinct from the Wi-Fi module, the secondary communication mode configured to transmit an alert to at least one other device in response to the triggering event.
